(19) United States
(12) Patent Application Publication
(10) Pub. No.: US 2004/0159039 A1
(43) Pub. Date: Aug. 19, 2004

(54) Illuminated fishing rod

(76) Inventors: Clifford A. Yates, Glen Ellyn, IL (US); Leo K. Kolesar, Glen Ellyn, IL (US)

Correspondence Address: Mr. Marc D. Machtinger, Esq., Law Office of Marc D. Machtinger, Ltd., 750 W. Lake Cook Road, Suite 350, Buffalo Grove, IL, 60089-2073, US

(21) Appl. No.: 10/366,980

(22) Filed: Feb. 14, 2003

(51) Int. Cl. A01K 75/02; A01K 85/00

(52) U.S. Cl. 43/17.5

(57) ABSTRACT

An illuminated fishing rod comprising a handle and an elongated pole, both having a hollow internal cavity is disclosed. The handle's internal cavity optionally stores lures, other fishing equipment, or components such as an audio output. The internal cavity of the elongated pole houses an electroluminescent wire along its length that illuminates the pole. The electroluminescent wire is connected to an optionally rechargeable power source that is mounted in the cavity of the handle. In one embodiment, the power source includes one or more battery cells. The pole and handle form a single piece or, alternatively, the pole is detachable from the handle such that substitute poles having different colors are provided. The pole optionally includes different modes of illumination and the rod optionally produces an indicating signal that a fish is biting.

### TECHNICAL FIELD

The present invention relates to an illuminated fishing rod, and more specifically to an illuminated fishing rod having a handle and an elongated pole which houses an electroluminescent wire.

### BACKGROUND OF THE INVENTION

Various illuminated fishing rods are known and utilized for numerous purposes. Several prior art references provide for an illuminated fishing rod, but the light source does not illuminate the length of the rod. Therefore, the illumination is not very bright and the rod is not sufficiently illuminated for the fisherman to see it. For example, U.S. Pat. No. 6,122,853, issued to Genous-Moore, provides for a portable fish strike indicator that transmits light through an optical fiber to the tip portion of the fishing rod. Standing from a distance, a fisherman would only be able to see a small portion of his pole. U.S. Pat. No. 6,079,144, issued to Morgan et al, provides for an illuminator that may be disposed inside a fishing lure. This would also provide little illumination for the fisherman.

Similarly, several prior art references do provide for an illuminated rod wherein the length of the rod is illuminated. However, in these disclosures, the light source is not disposed in a portion of the pole, therefore, the illumination is still not very bright. For example, U.S. Pat. No. 5,826,366, issued to Matibe, provides for an illuminated fishing rod wherein a flexible illuminating tube extends externally from the handle axially to the tip of the rod. While the exterior of the rod may be illuminated, the illuminating tube is thin and does not provide bright illumination. Similarly, U.S. Pat. No. 5,357,410, issued to Cota et al., also discloses a rod that only illuminates the pole's exterior.

Even in designs wherein the light illuminates the pole body, additional prior art references disclose a separate light source to provide the illumination. Only a light transmitter is disposed in the pole body. As a result, in these references, illumination dims as illumination longitudally moves down the length of the pole. For example, U.S. Pat. No. 6,149,286, issued to Wiggins, provides for an illuminated fishing rod wherein a laser beam in the handle provides the illumination for the pole body. U.S. Pat. No. 6,000,808, issued to Hansen, provides for a portable light-transmitting element, which can be placed inside a pole having an internal cavity. However, a portable light source must be mounted in the handle or made as part of the hollow pole body. Furthermore, U.S. Pat. No. 5,738,433, issued to Sparks, provides for an illuminated fishing rod wherein a light bulb and power source are mounted in the handle of the rod. In all the above disclosures, since the light source does not extend over a portion of the pole, the light dims as it moves longitudinally down the pole.

Other prior art references disclose illuminated rods that do not contain a continuous light source disposed in the pole body to provide bright illumination of the rod. U.S. Pat. No. 5,205,061, issued to Aragon, Jr., provides for a motion sensitive, fiber optic strike indicating fishing rod assembly. In this disclosure, a motion detector generates an electrical signal that activates a light source that is connected to a plurality of fiber optic elements throughout the rod. Again, the light source does not extend over the length of the rod. U.S. Pat. No. 5,205,061, issued to Echols, Jr., provides for a movement indicator for a fishing rod. When a fish strikes the pole, light is emitted from a light-emitting diode to a reflector cap by at least one length of optical wire. The light from the reflector cap signals that a fish has bitten.

Electroluminescent wire that is of the type described in this disclosure for use in an illuminated fishing rod is not known to date. U.S. Pat. No. 5,730,079, issued to Totty et al., simply provides for an electroluminescent light that may be mounted to a boat to allow one to distinguish the water from the shoreline, but did not suggest use in an illuminated fishing rod. U.S. Pat. No. 5,496,427, issued to Gustafson et al, provides for an improved process for manufacturing electroluminescent light strips wherein the phosphor matrix is protected from moisture by a polymeric plastic material. U.S. Pat. No. 5,959,402, issued to Polyan, provides for an electroluminescent light source comprising a core member sandwiched between a pair of transparent band structures, forming a transparent sheath. U.S. Pat. No. 5,951,140, issued to Feldman, provides for a display unit, which contains a plurality of flexible, elongated electroluminescent light sources. In this disclosure, an electrolumiphor powder may be used to differentiate the color emitted by the electroluminescent light source but this reference does not disclose using the powder to have interchangeable fishing rods of different colors. None of the above references disclose the use of electroluminescent wire to illuminate a fishing rod or interchanging rods of different colors on a fishing rod.

It would be desirable to provide an illuminated fishing rod wherein an electroluminescent light source is disposed within the interior pole cavity. It would also be desirable to provide such a rod in which poles of different colors may be utilized.

### SUMMARY

In view of the insufficiencies discussed above, it is an object of the present invention to provide an illuminated fishing rod wherein an electroluminescent wire is disposed in a hollow pole body. It is a further object of the present invention to provide for various additional features and functions as described herein.

In accordance with the above objectives, an illuminated rod is provided with an electroluminescent wire disposed in a hollow pole body. A rod capable of having poles of different colors is also provided.

Preferably, the illuminated fishing rod of the present invention comprises a handle with an interior handle cavity that can optionally be compartmentalized to provide a storing means or may house additional components. An elongated hollow pole extends from the handle. The handle and pole form a single piece or, alternatively, the pole is detachably connected to the handle by any suitable means of connection such as a snap-fit connection, frictional fitting, or threading. In one preferred embodiment, the pole is constructed of two elongated pieces that are connected end to end in serial by a threaded connection, frictional fitting, a snap fit connection, or any other suitable means of connection. The pole has a non-opaque outer wall and also has an interior pole cavity. An electroluminescent wire is disposed within the interior pole cavity and along the length of the pole. A power source, optionally rechargeable by solar energy, is disposed within the interior cavity of the handle. Preferably, the power source comprises a battery cell or battery cells.

The power source is operatively connected to the electroluminescent wire such that the electroluminescent wire is illuminated when the power source is connected to it. The illumination may be continuous or pulsating and may be of different colors. The non-opaque wall of the pole is preferably transparent and is optionally tinted with a color that correlates to the color the electroluminescent wire illuminates. Interchangeable rods having tints of different colors are provided.

In one embodiment, the rod has a sensor to trigger a change in the illumination from off to on, or from continuous to pulsating, or from dim to bright. In a further embodiment, the rod has a sensor that is coupled to a transmitter that transmits a signal to a remote receiver to produce an indicating signal that a fish is biting.

A method for manufacturing the device of the present invention is additionally intended within the scope of the invention, as detailed herein.

Other features and advantages of the invention will be apparent from the following detailed description taken in conjunction with the following drawings.

### BRIEF DESCRIPTION OF THE DRAWINGS

FIG. 1 is a side view of a preferred embodiment of the present invention.

FIG. 2 is a side view of another preferred embodiment of the present invention showing a connecting means for two portions of the elongated pole body.

FIG. 3 is a side view of yet another preferred embodiment of the present invention showing a connecting means for the electroluminescent wire.

FIG. 4A is an exploded view of the handle of the present invention.

FIG. 4B is a conceptual view of a preferred embodiment of the present invention including a remote receiver receiving a transmitted signal.

FIG. 5 is an exploded view of another embodiment of the present invention.

FIG. 6 is a cut-away view of a prior art electroluminescent wire used in conjunction with the present invention.

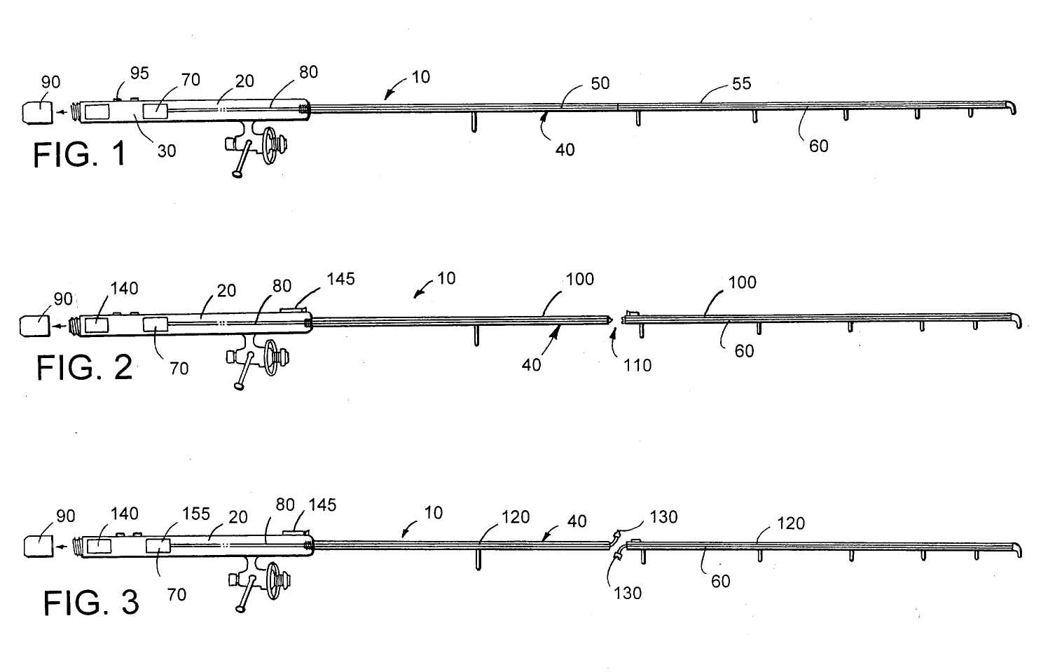

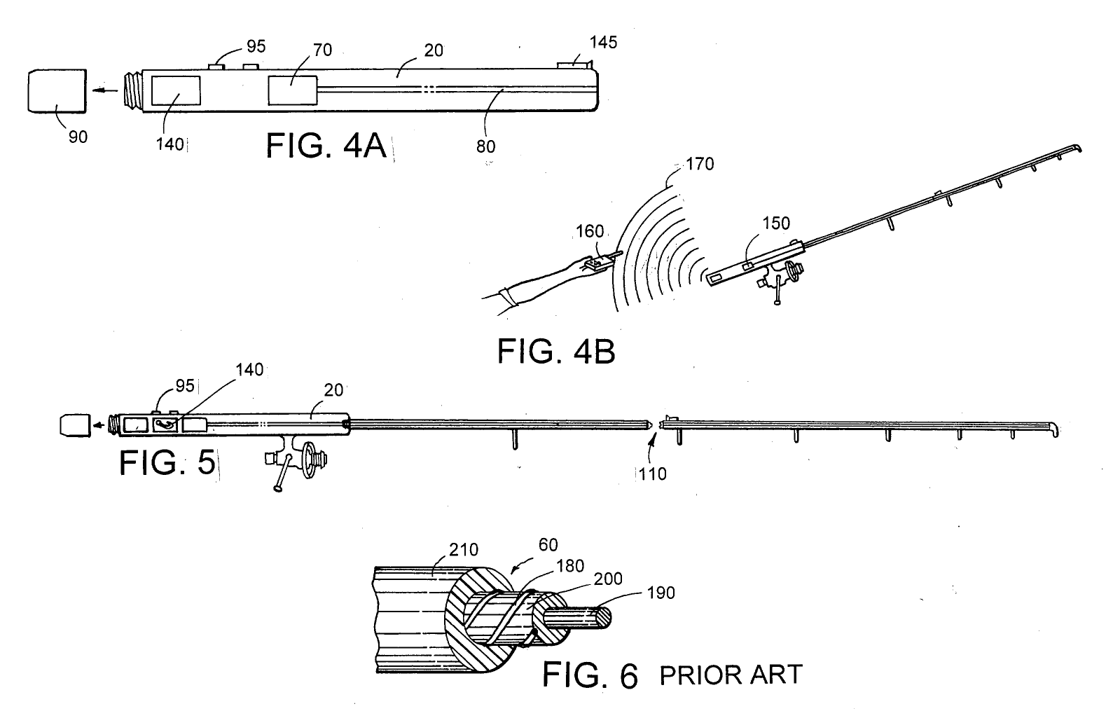

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

The illuminated fishing rod 10 comprises a handle 20 having an interior handle cavity 30, an elongated hollow pole 40 extending from the handle 20, the pole 40 also having an interior pole cavity 50 and a non-opaque outer wall 55. The pole 40 and handle 20 form a single piece or, alternatively, the pole 40 is detachable from the handle 20. An electroluminescent wire 60 is disposed within the interior pole cavity 50 and along a length of the pole 40 and illuminates the pole 40. Preferably, the electroluminescent wire 60 is disposed along substantially the entire length of the pole 40. The electroluminescent wire 60 preferably is a copper wire 190 coated with a phosphorus material 200 and wrapped with two tiny transmitter wires 180. The electroluminescent wire 60 is then sealed in a waterproof casing 210. A power source 70 causes the electroluminescent wire 60 to glow. The lower the frequency, the dimmer it glows, the higher the frequency, the brighter it glows.

In a preferred embodiment, the power source 70 is disposed within the interior handle cavity 30 and is operatively connected to the electroluminescent wire 60. The power source 70 is preferably connected to the electroluminescent wire 60 via a set of wires 80. The electroluminescent wire 60 is illuminated when the power source 70 is operatively connected to the electroluminescent wire 60, such as via the connecting wires 80. Access to the power source 70 is optionally via a detachable end cap 90 or a side panel or a removable panel in the handle. Preferably, the power source 70 comprises a battery cell or battery cells or any other suitable energy source. The power source 70 optionally includes a solar panel unit for recharging the power source by solar energy. Any other suitable means of recharging the power source by solar energy may also be used.

In another preferred embodiment, the illuminated fishing rod contains a switch 95 that is operatively connected to the power source 70 for selectively switching the power source 70 on and off.

In another preferred embodiment, the electroluminescent wire 30 is optionally adapted to be selectively switched between a continuous illumination mode and a pulsating mode. In a further preferred embodiment, the pole 40 is constructed of at least two elongated pole members 100, detachably connected in serial via a connection 110. The connection 110 is preferably a snap fitting, frictional fitting, or a threaded connection or any other means of making a secure connection 110. The electroluminescent wire 60 is composed of a single piece, or is optionally composed of at least two portions 120. The two portions are connected in serial by a snap fitting 130 or any other means of making a secure electrical connection.

In yet another preferred embodiment, the non-opaque wall 55 of the pole 40 are tinted with a first color. This first color preferably correlates with a second color emitted by the electroluminescent wire 60. Colors correlate if they are the same general color, including any shade of that color. When the emitted color correlates with the tinting of the pole 40, the illumination may be enhanced. Poles 40 having different tints can be detachably mounted to the handle 20. Therefore, poles 40 having different tints can be interchangeably attached to the handle 20 as desired. Additionally, if the handle 20 and pole 40 form a single piece, rods having poles of different colors are optionally provided.

In one preferred embodiment, the non-opaque wall 55 is preferably constructed of fiberglass. The interior handle cavity 30 optionally has a compartment 140 for housing additional components such as fishing lures, equipment, a radio device, an audio component, or any other component that may be housed in the interior handle cavity 30. The compartment 140 may be segregated from the power source 70, but need not be, it only need be additional space within the interior handle cavity 30.

The illuminated fishing rod 10 may optionally includes a sensor 145 that is operatively connected to the electroluminescent wire 60. The sensor 145 effects a change in the illumination mode of the electroluminescent wire 60 upon sensing a biting action on the pole 40. A biting action can be any movement of the fishing rod 10, which is likely to be caused by a biting fish. The sensor 145 may be one that detects motion, changes in pressure, or any other means of determining the presence of a biting fish. The change in the illumination mode may be from off to on, continuous to pulsating, or from dim to bright. The sensor 145 optionally triggers an audio output upon sensing a biting action via a speaker 155 in the rod's 10 handle 20.

The illuminated fishing rod 10 optionally further comprises a transmitter 150 and a remote receiver 160, wherein the sensor 145 triggers the transmitter 150 to transmit a signal 170 to the receiver 160, and wherein the receiver 160 emits an indication of such biting action upon receiving the signal 170. The indication may be an audio signal, a visual signal or any other means of indication.

The present invention further encompasses, within its scope, a method for manufacturing an illuminated fishing rod as described above. The method generally includes the steps of providing a handle 20 with an interior handle cavity 30 and an elongated hollow pole 40 extending from said handle 20, the pole 40 having an internal pole cavity 50 and having a non-opaque wall 55, disposing an electroluminescent wire 60 within the internal pole cavity 50, and operatively connecting the electroluminescent wire 60 to a power source 70. The method also includes the steps of providing each of the additional features and components as described above.

While the specific embodiments have been illustrated and described, numerous modifications come to mind without significantly departing from the spirit of the invention, and the scope of protection is only limited by the scope of the accompanying claims.

What is claimed is:

1. An illuminated fishing rod comprising:
a handle having an interior handle cavity,
an elongated hollow pole extending from said handle, said pole having a non-opaque outer wall and an interior pole cavity,
an electroluminescent wire disposed within the interior pole cavity and along a length of said pole, and
a power source disposed within the interior handle cavity operatively connected to said electroluminescent wire such that said wire is illuminated when said power source is operatively connected thereto.

2. The illuminated fishing rod according to claim 1, wherein a detachable end cap in said handle provides access to said power source for a user.

3. The illuminated fishing rod according to claim 1, wherein access to said power source is provided via a panel in said handle.

4. The illuminated fishing rod according to claim 1, wherein the power source comprises at least one battery cell.

5. The illuminated fishing rod according to claim 1, further comprising a switch that is operatively connected to said power source for selectively switching said power source on and off.

6. The illuminated fishing rod according to claim 1, wherein said elongated pole is detachably mounted to said handle.

7. The illuminated fishing rod according to claim 1, wherein said electroluminescent wire is adapted to be selectively switched between a continuous illumination mode and a pulsating mode.

8. The illuminated fishing rod according to claim 1, wherein said elongated pole comprises at least two elongated pole members detachably connected in serial via a connecting means.

9. The illuminated fishing rod according to claim 8, wherein said electroluminescent wire has two portions comprising a first one of said portions disposed in a first one of said pole members, and a second one of said portions disposed in a second one of said pole members operatively connected to the first one of said portions.

10. The illuminated fishing rod according to claim 8, wherein said connecting means is a threaded interface.

11. The illuminated fishing rod according to claim 9, wherein said connecting means is a threaded interface.

12. The illuminated fishing rod according to claim 8, wherein said connecting means is a snap-fit fitting.

13. The illuminated fishing rod according to claim 9, wherein said connecting means is a snap-fit fitting.

14. The illuminated fishing rod according to claim 1, wherein the non-opaque wall is tinted with a first color, and wherein said electroluminescent wire emits light in a second color which correlates to the first color of said wall.

15. A system including the illuminated fishing rod according to claim 14, further comprising at least one substitute pole having a tint which is different from said first color and is selectively interchangeable with any other pole of the system.

16. The illuminated fishing rod according to claim 1, wherein the pole is comprised of fiberglass.

17. The fishing rod according to claim 1, wherein the interior handle cavity has a compartment for housing an additional component.

18. The fishing rod according to claim 1, further comprising a means for recharging the power source by solar energy.

19. The illuminated fishing rod according to claim 1, further comprising a sensor operatively connected to said electroluminescent wire, said sensor effecting a change in an illumination mode of said elctroluminescent wire upon sensing a biting action on said pole.

20. The illuminated fishing rod according to claim 19, wherein said sensor triggers a change in the illumination mode of said electroluminescent wire from off to on upon sensing such a biting action on said pole.

21. The illuminated fishing rod according to claim 19, wherein said sensor triggers a change in the illumination mode of said electroluminescent wire from continuous to pulsating upon sensing such a biting action on said pole.

22. The illuminated fishing rod according to claim 19, wherein said sensor triggers a change in the illumination mode of said electroluminescent wire from dim to bright upon sensing such a biting action on said pole.

23. The illuminated fishing rod according to claim 19, wherein said sensor further triggers an audio output upon sensing such a biting action.

24. The illuminated fishing rod according to claim 23, wherein the audio output is transmitted through a speaker in said handle.

25. The illuminated fishing rod according to claim 19, further comprising a transmitter and a remote receiver, wherein said sensor further triggers said transmitter to transmit a signal to said receiver, and wherein said receiver emits an indication of such a biting action upon receiving said signal.

26. The illuminated fishing rod according to claim 25, wherein the indication is an audio signal.

27. The illuminated fishing rod according to claim 26, wherein the indication is visual signal.

28. A method for manufacturing an illuminated fishing rod comprising the steps of:
providing a handle with an interior handle cavity and an elongated hollow pole extending from said handle, said pole having an internal pole cavity and having a non-opaque outer wall,
disposing an electroluminescent wire within the cavity of said pole, and
operatively connecting the electroluminescent wire to a power source.

29. The method according to claim 28, further comprising operatively connecting said power source to a power switch.

30. The method according to claim 28, wherein said pole is detachably mounted to said handle.

31. The method according to claim 28, wherein said electroluminescent wire is adapted to be selectively switched between a continuous illumination mode and a pulsating mode.

32. The method according to claim 28, further comprising forming said elongated pole from two elongated pole members detachably connected via a connecting means.

33. The method according to claim 32, further comprising forming said electroluminescent wire from two electroluminescent wire segments, said segments operatively connected to one another, and each of said segments being disposed within a respective one of said pole members.

34. The method according to claim 28, further comprising providing said non-opaque wall with a tint composed of a first color, and wherein said electroluminescent wire emits light in a second color which correlates to the first color of said wall.

35. The method according to claim 28, further comprising providing a compartment for housing an additional component in said interior handle cavity.

36. The method according to claim 28, wherein said power source is adapted to be recharged by solar energy.

37. The method according to claim 28, further comprising providing a sensor operatively connected to said electroluminescent wire, said sensor effecting a change in the illumination mode of said elctroluminescent wire upon sensing a biting action on said pole.

38. The method according to claim 37, further comprising providing a transmitter and a remote receiver, wherein said sensor further triggers said transmitter to transmit a signal to said receiver, and wherein said receiver emits an indication of such a biting action upon receiving said signal.

39. The method according to claim 28, wherein said power source comprises at least one battery cell.
